(19) United States
(12) Patent Application Publication
(10) Pub. No.: US 2025/0021620 A1
(43) Pub. Date: Jan. 16, 2025

(54) SERVER-ASSISTED SECURE TWO-PARTY INVERSION COMPUTATION METHOD, SYSTEM AND APPARATUS

(71) Applicant: Beihang University, Beijing (CN)

(72) Inventors: Haogang ZHU, Beijing (CN); Shizhao PENG, Beijing (CN); Derun ZHAO, Beijing (CN)

(21) Appl. No.: 18/525,590

(22) Filed: Nov. 30, 2023

(30) Foreign Application Priority Data
Jul. 10, 2023 (CN) 2023108419760

(51) Int. Cl. G06F 17/16; H04L 9/00

(52) U.S. Cl. CPC G06F 17/16; H04L 9/008

(57) ABSTRACT

A server-assisted secure two-party inversion computation method, system, and apparatus are disclosed, relating to the field of data security. The method includes the following steps: the participant node A, the participant node Bob, the auxiliary computing node P, the auxiliary computing node Q, and the auxiliary computing node S perform a third three-party matrix multiplication based on a secure three-party matrix multiplication protocol 3PMP, and a result of the three-party matrix multiplication is randomly split into private matrices, which are then sent to a party requesting the secure two-party inversion computation, to obtain a final result of the two-party inversion computation. The present disclosure has characteristics such as parallelism, security, reliability, and the ability to effectively resist collusion among a plurality of server nodes.

### CROSS REFERENCE TO RELATED APPLICATION

This patent application claims the benefit and priority of Chinese Patent Application No. 2023108419760, filed with the China National Intellectual Property Administration on Jul. 10, 2023, the disclosure of which is incorporated by reference herein in its entirety as part of the present application.

### TECHNICAL FIELD

The present disclosure relates to the field of data security, and in particular, to a server-assisted secure two-party inversion computation method, system and apparatus.

### BACKGROUND

With the innovation and application of artificial intelligence and big data technologies, the world has officially entered the “data-driven” era, and data has become an important strategic resource for countries and enterprises. In practical production, data computation involves a large number of matrix-based calculations, where the inverse matrix plays a crucial role, especially in various fields such as data analysis, signal processing, modern control theory, and network theory. However, as users' concerns about personal data security and privacy continue to grow, how to achieve large-scale matrix inversion with computational correctness, transaction security, and stable computational accuracy while ensuring that the original data is not leaked has become an important research direction in computational problems related to complex data analysis.

In the existing technical solutions, Benjamin and Atallah proposed a multi-server verifiable matrix inversion outsourcing scheme based on homomorphic encryption. The computational complexity for the user is O(n²t²), where n is the order of the matrix, and t is the threshold of the matrix. While Benjamin and Atallah's computation scheme effectively protects the privacy of input data and ensures verifiability of the computation, it suffers from decreased computational efficiency due to the introduction of homomorphic encryption. Additionally, there is a risk of privacy leakage since a third-party cloud service provider involved in the outsourcing is vulnerable to conspiracy attacks. Lei and Ren et al. proposed an efficient and verifiable blind technique for matrix inversion and matrix multiplication based on random permutation of sparse matrices and Monte-Carlo verification algorithm. The core idea is to encrypt an original large-scale matrix by multiplication with a specially designed sparse matrix, and then perform computation and decrypt resulting ciphertext on the cloud. While Lei et al.'s approach improves the efficiency of outsourcing computations on the cloud, it relies on the invertibility of the blind matrix inversion. This introduces the potential security risk of information leakage for local zero-element data in the original matrix and loss of precision for inversion computation of ill-conditioned data matrices. Fiore et al. proposed a publicly verifiable shared computation model for higher-order polynomial and matrix inversion based on different cryptographic hardness assumptions (such as co-CDH hardness assumption and decisional linear hardness assumption) and secret sharing techniques. While Fiore et al.'s approach improves the overall computational security, it introduces a significant increase in computational overhead due to the involvement of numerous public-key cryptographic tools. Additionally, the secret sharing scheme is related to a finite field, which leads to loss of precision in the computation. Zhen and Jia et al. proposed a secure two-party matrix inversion protocol for solving n-order matrix equation systems by utilizing OT₁ⁿ oblivious transfer protocols. Zhen et al.'s approach, based on OT₁ⁿ oblivious transfer, involves a significant number of communication rounds. As a result, it suffers from high communication costs and low computational efficiency when dealing with large-scale data matrix inversion tasks.

The existing solutions for two-party secure matrix inversion computation problems rely on cryptographic techniques such as homomorphic encryption, oblivious transfer, and secret sharing, which significantly increases the computational complexity of the client-side ciphertext space and results in multiplied communication overhead. Many existing solutions for two-party secure matrix inversion computation problems depend on outsourced cloud service computation systems, while collusion among third-party cloud computing nodes may lead to privacy leakage of the original data provider, causing security risks. The use of large prime number encryption in the existing solutions for two-party secure matrix inversion computation problems increases the ciphertext size in computation space; moreover, the fixed-length limitation of ciphertexts directly causes the loss of numerical precision, which affects the reliability of the computed results.

### SUMMARY

An objective of the present disclosure is to provide a server-assisted secure two-party inversion computation method, system and apparatus, which have characteristics such as parallelism, security, reliability, and the ability to effectively resist collusion among a plurality of server nodes.

To achieve the above objective, the present disclosure provides the following technical solutions.

A server-assisted secure two-party inversion computation method includes:
performing a first round of three-party matrix multiplication based on a secure three-party matrix multiplication protocol 3PMP according to a private matrix A of a participant node Alice, a private matrix P of an auxiliary computing node P, and a private matrix Q of an auxiliary computing node Q, to obtain a first three-party matrix multiplication result;
splitting the first three-party matrix multiplication result into a matrix Vₐ, a matrix Vₚ₁, and a matrix V_{q1} by using a data random obfuscation technique; and sending the matrix Vₐ, the matrix Vₚ₁, and the matrix V_{q1} to the participant node Alice, the auxiliary computing node P, and the auxiliary computing node Q respectively, where Vₐ, Vₚ₁, V_{q1}∈R^{n×n}, and Vₚ₁+Vₐ+V_{q1}−P×A×Q;
performing a second round of three-party matrix multiplication based on the 3PMP according to a private matrix B of a participant node Bob, the private matrix P of the auxiliary computing node P, and the private matrix Q of the auxiliary computing node Q, to obtain a second three-party matrix multiplication result;
splitting the second three-party matrix multiplication result into a matrix V_{b}, a matrix Vₚ₂, and a matrix V_{q2} by using the data random obfuscation technique; and sending the matrix V_{b}, the matrix Vₚ₂, and the matrix V_{q2} to the participant node Bob, the auxiliary computing node P, and the auxiliary computing node Q respectively, where V_{b}, Vₚ₂, V_{q2}∈R^{n×n}, and Vₚ₂+V_{b}+V_{q2}=P×B×Q;
sending a computation result Vₚ=Vₚ₁+Vₚ₂ of local secret computation of the auxiliary computing node P to an auxiliary computing node S;
sending a computation result V_{q}=V_{q1}+V_{q2} of local secret computation of the auxiliary computing node Q to the auxiliary computing node S;
sending the matrix Vₐ of the participant node Alice and the matrix V_{b} of the participant node Bob to the auxiliary computing node S;
obtaining, by the auxiliary computing node S, a matrix T=Vₐ+V_{b}+V_{q}+Vₚ=PAQ+PBQ=P(A+B)Q by using the computation result Vₐ, the computation result Vₐ, the matrix Vₐ, and the matrix V_{b}, and performing local computation to a matrix T⁻¹=Q⁻¹(A+B)⁻¹P⁻¹, where T∈R^{n×n};
performing a third round of three-party matrix multiplication based on the 3PMP protocol according to the private matrix P of the auxiliary computing node P, the private matrix Q of the auxiliary computing node Q, and the matrix T⁻¹ of the auxiliary computing node S, to obtain a third three-party matrix multiplication result;
randomly splitting the third three-party matrix multiplication result into a private matrix U_{P}, a private matrix U_{S}, and a private matrix U_{Q}, where U_{P}, U_{S}, U_{Q}∈R^{n×n}; and
sending the private matrix U_{P}, the private matrix U_{S}, and the private matrix U_{Q} to a requesting party of secure two-party inversion computation to obtain a final result of the two-party inversion computation, where the participant node Alice owns the private matrix A∈R^{n×n}, the participant node Bob owns the private matrix B∈R^{n×n}, the auxiliary computing node P owns the random invertible matrix P∈R^{n×n}, and the auxiliary computing node Q owns the random invertible matrix Q∈R^{n×n}.

Optionally, the final result of the two-party inversion computation is:

Uₚ+Uₛ+U_{q}=QT⁻¹P=Q(Vₐ+Vₚ+V_{q}+V_{b})⁻¹P

Uₚ+Uₛ+U_{q}=Q[(Vₚ₁+Vₐ+V_{q1})+(Vₚ₁+V_{b}+V_{q2})]⁻¹P.

Optionally, the participant node Alice, the participant node Bob, the auxiliary computing node P, the auxiliary computing node Q, and the auxiliary computing node S satisfy a constraint ψ(P Node,A Node,Q Node)=ϕ, a constraint ψ(A Node,B Node)={ϕ}, and a semi-honest model,

where ψ represents the participant node Bob, the auxiliary computing node P, and the auxiliary computing node Q do not collude with each other and have an empty set for shared data, and ψ(A Node,B Node)={ϕ} represents that collusion between the participant node Alice and the participant node Bob is prohibited.

Optionally, the secure three-party multiplication protocol of the 3PMP protocol is implemented using secret sharing, oblivious transfer, garbled circuit framework ABY3, and fully homomorphic encryption.

A server-assisted secure two-party inversion computation system includes:
a first computation unit configured to perform a first round of three-party matrix multiplication based on a secure three-party matrix multiplication protocol 3PMP according to a private matrix A of a participant node Alice, a private matrix P of an auxiliary computing node P, and a private matrix Q of an auxiliary computing node Q, to obtain a first three-party matrix multiplication result;
a first sending unit configured to split the first three-party matrix multiplication result into a matrix Vₐ, a matrix Vₚ₁, and a matrix V_{q1} by using a data random obfuscation technique; and send the matrix Vₐ, the matrix Vₚ₁, and the matrix V_{q1} to the participant node Alice, the auxiliary computing node P, and the auxiliary computing node Q respectively, where Vₐ, Vₚ₁, V_{q1}∈R^{n×n}, and Vₚ₁+Vₐ+V_{q1}=P×A×Q;
a second computation unit configured to perform a second round of three-party matrix multiplication based on the 3PMP according to a private matrix B of a participant node Bob, the private matrix P of the auxiliary computing node P, and the private matrix Q of the auxiliary computing node Q, to obtain a second three-party matrix multiplication result;
a second sending unit configured to split the second three-party matrix multiplication result into a matrix V_{b}, a matrix Vₚ₂, and a matrix V_{q2} by using the data random obfuscation technique; and send the matrix V_{b}, the matrix Vₚ₂, and the matrix V_{q2} to the participant node Bob, the auxiliary computing node P, and the auxiliary computing node Q respectively, where V_{b}, Vₚ₂, V_{q2}∈R^{n×n}, and Vₚ₂=V_{b}+V_{q2}=P×B×Q;
a first computation result sending unit configured to send a computation result Vₚ=Vₚ₁+Vₚ₂ of local secret computation of the auxiliary computing node P to an auxiliary computing node S;
a second computation result sending unit configured to send a computation result V_{q}=V_{q1}|V_{q2} of local secret computation of the auxiliary computing node Q to the auxiliary computing node S;
a third sending unit configured to send the matrix Vₐ of the participant node Alice and the matrix V_{b} of the participant node Bob to the auxiliary computing node S;
a computation unit of auxiliary computing node S, configured to obtain, by the auxiliary computing node S, a matrix T=Vₐ+V_{b}+V_{q}+Vₚ=PAQ+PBQ=P(A+B)Q by using the computation result Vₐ, the computation result Vₐ, the matrix Vₐ, and the matrix V_{b}, and perform local computation to obtain a matrix T⁻¹=Q⁻¹(A+B)⁻¹P⁻¹, where T∈R^{n×n};
a third computation unit configured to perform a third round of three-party matrix multiplication based on the 3PMP protocol according to the private matrix P of the auxiliary computing node P, the private matrix Q of the auxiliary computing node Q, and the matrix T⁻¹ of the auxiliary computing node S, to obtain a third three-party matrix multiplication result;
a private matrix splitting unit configured to randomly split the three-party matrix multiplication result into a private matrix U_{P}, a private matrix U_{S}, and a private matrix U_{U}, where U_{P}, U_{S}, U_{Q}∈R^{n×n}; and
a two-party inversion computation result determining module configured to send the private matrix U_{P}, the private matrix U_{S}, and the private matrix U_{Q} to a requesting party of secure two-party inversion computation to obtain a final result of the two-party inversion computation, where the participant node Alice owns the private matrix A∈R^{n×n}, the participant node Bob owns the private matrix B∈R^{n×n}, the auxiliary computing node P owns the random invertible matrix P∈R^{n×n}, and the auxiliary computing node Q owns the random invertible matrix Q∈R^{n×n}.

A server-assisted secure two-party inversion computation apparatus, which is applied to the server-assisted secure two-party inversion computation method, includes a task acquisition module, a secure computation module, a rule generation module, a consensus computation module, and a data transmission module.

The task acquisition module is configured to receive and decode a privacy-preserving computation request from a client.

The secure computation module is configured to automatically match a corresponding two-party secure computation protocol according to the parsed privacy-preserving computation request.

The rule generation module is configured to implement computation task decomposition according to an asynchronous instruction set of the secure computation protocol, where different participant nodes execute collaborative computation according to respective rules.

The consensus computation module is configured to ensure synchronicity and result consistency of computation processes by using a consensus protocol after receiving assigned sub-rules.

The data transmission module is configured to collect computation results from participant nodes and transmit the computation results to a computation requesting party after the computation is completed.

After receiving a request for matrix inversion computation, the task acquisition module parses the request and initiates secure computation service processes for the corresponding computation participant node A, participant node Bob, auxiliary computing node P, auxiliary computing node Q, and auxiliary computing node S. After parsing corresponding computation requirements, the task acquisition module passes the computation requirements to the secure computation module. A joint query is performed through an internal interface of the secure computation module. After a corresponding secure computation protocol is found through matching, the secure computation protocol is synchronized to the rule generation modules in the participant node A, participant node Bob, auxiliary computing node P, auxiliary computing node Q, and auxiliary computing node S. The rule generation module then formulates different asynchronous parallel execution processes according to different subtasks assigned to the participant node A, participant node Bob, auxiliary computing node P, auxiliary computing node Q, and auxiliary computing node S, and maintains communication with the consensus computation module at each step of the execution. While the participant node A, participant node Bob, auxiliary computing node P, auxiliary computing node Q, and auxiliary computing node S execute computation instructions at each step, the consensus computation module broadcasts and maintains result consistency of the distributed computing nodes on the chain, and controls the stability of the execution process. Once the execution of the computation protocol is completed, the two computation participant node A and participant node Bob obtain computation sub-results from each other, and send, through the respective data transmission modules, the obfuscated and split sub-matrices to the requesting party, to obtain a correct computation result.

According to specific embodiments provided in the present disclosure, the present disclosure has the following technical effects:

The present disclosure provides a server-assisted secure two-party inversion computation method, system and apparatus. The present disclosure aims to propose a low-cost, high-precision, and user-friendly two-party secure matrix inversion computation method, to address the issue of high computational overhead in existing solutions that use oblivious transfer or homomorphic encryption schemes. The present disclosure aims to achieve a reliable method that effectively resists collusion among multiple nodes, to solve the security issues caused by local data information (zero elements) or collusion in existing privacy-preserving computation protocols that do not involve cryptographic tools. The present disclosure aims to realize a secure two-party inversion protocol for real number field floating-point matrix inversion operations, to ensure the accuracy stability and result reliability of the final computation result. By introducing three semi-honest external server nodes to assist in privacy-preserving computation, the present disclosure solves the problem of data privacy leakage caused by excessive reliance on a single centralized third-party cloud computing service provider in the prior art, and achieves a highly secure computation scheme that effectively resists collusion among multiple server nodes. The present disclosure aims to realize a two-party inversion computation protocol that ensures both process-level security and result security, addressing the limitations of existing privacy protocols that rarely consider both result security and process security simultaneously.

### BRIEF DESCRIPTION OF THE DRAWINGS

To describe the technical solutions in embodiments of the present disclosure or in the prior art more clearly, the accompanying drawings required for the embodiments are briefly described below. Apparently, the accompanying drawings in the following description show merely some embodiments of the present disclosure, and those of ordinary skill in the art may still derive other accompanying drawings from these accompanying drawings without creative efforts.

FIG. 1 is a schematic flowchart of a server-assisted secure two-party inversion computation method according to the present disclosure;

FIG. 2 is a two-party secure matrix inversion computation method based on a 3PMP protocol;

FIG. 3 is a schematic diagram of a secure two-party matrix inversion computation problem;

FIG. 4 is a schematic diagram of a three-party secure matrix multiplication problem;

FIG. 5 is a flowchart of a three-party secure multiplication method;

FIGS. 6A-C are analysis chart of collusion resistance performance of a secure two-party matrix inversion protocol;

FIG. 7 is a schematic diagram of a technical solution of data obfuscation; and

FIG. 8 is a schematic structural diagram of a server-assisted secure two-party inversion computation apparatus according to the present disclosure.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other embodiments obtained by those skilled in the art based on the embodiments of the present disclosure without creative efforts shall fall within the protection scope of the present disclosure.

An objective of the present disclosure is to provide a server-assisted secure two-party inversion computation method, system and apparatus, which have characteristics such as parallelism, security, reliability, and the ability to effectively resist collusion among a plurality of server nodes.

In order to make the above objective, features and advantages of the present disclosure clearer and more comprehensible, the present disclosure will be further described in detail below in combination with accompanying drawings and particular implementation modes.

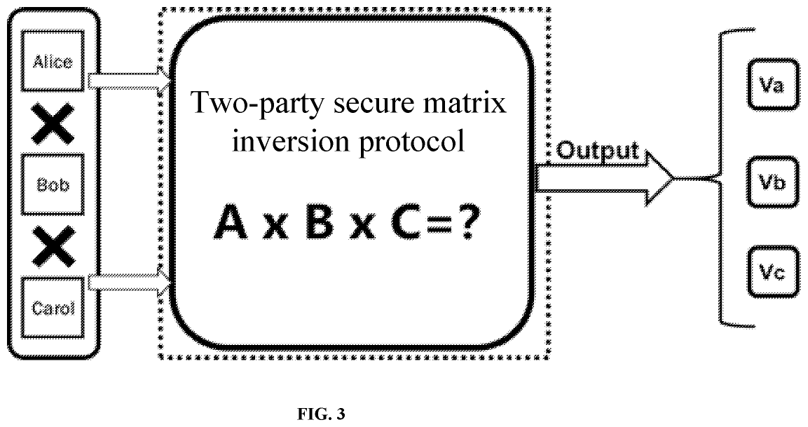

As shown in FIG. 3, it is known that there are two participant nodes, Alice and Bob, which are independent and mutually distrusting, Alice holds a private data matrix A∈R^{n×m} that is only stored in its own computing node, and Bob holds a private data matrix B∈R^{n×n}. The two participant jointly execute a two-party matrix inversion computation protocol f(A,B)=(A+B)⁻¹=Vₐ+V_{b}. Eventually, each participant node of the computation obtains its corresponding output matrix Vₐ, V_{b}∈R^{n×n} and sends the output matrix to the computation requesting party, who aggregates the output matrices to obtain an expected result of the two-party matrix inversion computation. During the computation process, each participant node can only obtain input/output information related to its own computation process, and cannot access intermediate computation results and private data information of the other participant.

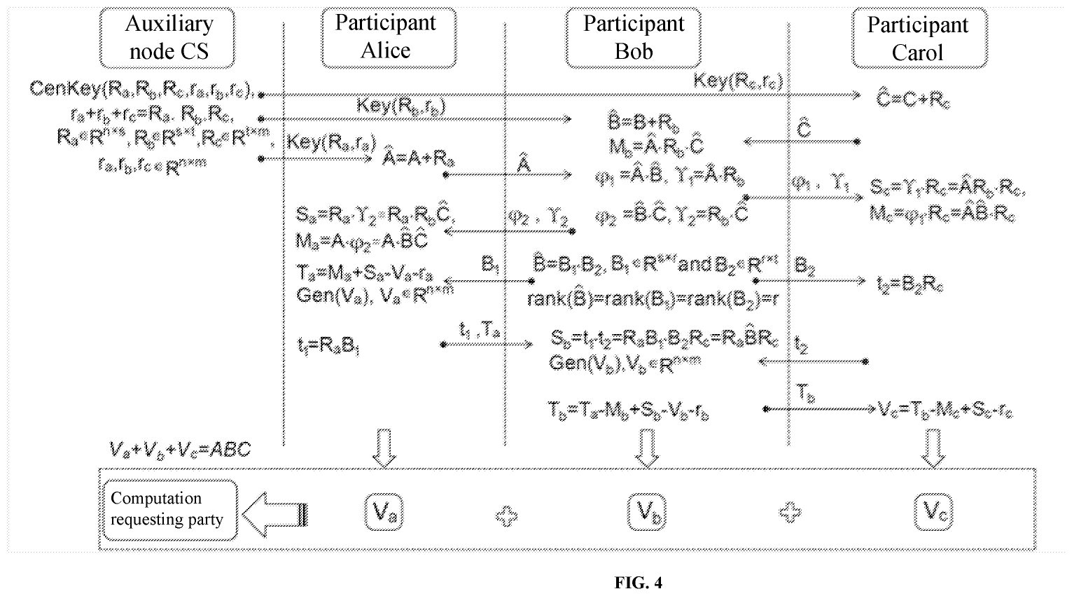

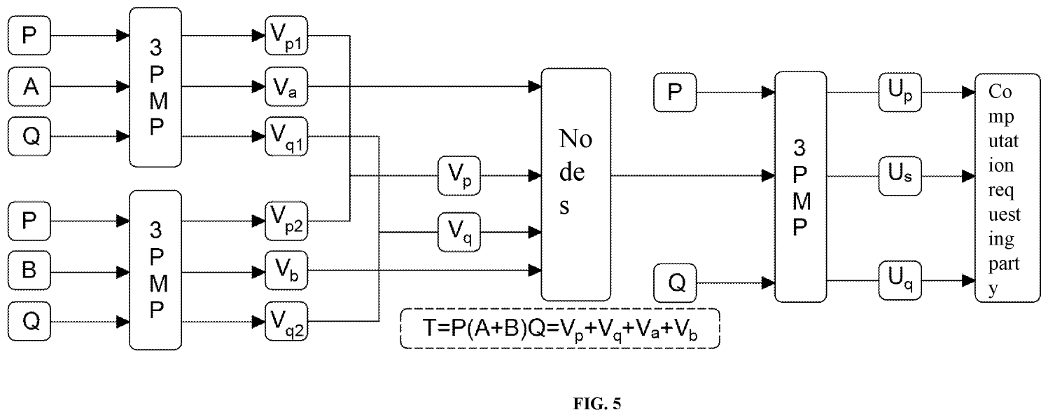

As shown in FIG. 4, it is known that there are three participants, Alice, Bob, and Carol, which are independent of each other and mutually distrusting. Alice holds an n×s-dimensional private data matrix A that is only stored in its own computing node, Bob holds an s×t-dimensional private data matrix B, and Carol holds a t×m-dimensional private data matrix C. The three participants perform a three-party matrix multiplication protocol computation f(A,B,C)=ABC=Vₐ+V_{b}+V_{c}, and finally the computation participant nodes obtain their respective n×m-dimensional output matrices Vₐ, V_{b}, V_{c}, which are sent to a computation requesting party to aggregate to obtain a desired three-party matrix product result. During the computation process, each participant node can only know its own input/output information, and cannot obtain intermediate computation results and data information of other participants. As shown in FIG. 5, a specific protocol process is as follows:

Step 1: An auxiliary computing node, also referred to as a commodity server (CS) node, generates three random matrix pairs. Specific forms of the three random matrix pairs are: an n×s-dimensional random matnx Rₐ, an s×t-dimensional random matrix R_{b}, a t×m-dimensional random matrix R_{c}, and three n×m-dimensional random matrices rₐ, r_{b}, r_{c}. These random matrices need to strictly follow the constraint rₐ+r_{b}+r_{c}=Rₐ·R_{b}·R_{c}. Then, the CS auxiliary computing node sends a random matrix pair (Rₐ, rₐ) to the participant computing node Alice, a random matrix pair (R_{b}, r_{b}) to the participant computing node Bob, and a random matrix pair (R_{c}, r_{c}) to the participant computing node Carol. During execution of the entire computation protocol, the CS auxiliary computing node needs to strictly meet the following three requirements: (1) Not access private data information related to Alice, Bob and Carol, whether an input or output result of an intermediate computation process. (2) Not collude with any participant computing node. (3) Strictly follow a protocol process to correctly execute an assigned sub-task. The CS auxiliary computing node does not directly participate in a subsequent actual computation process of the secure three-party multiplication, but only provides random matrix pairs independent of private data matrices at an initial phase of protocol execution, thereby protecting information of private matrices of the participants and ensuring security of raw data in the subsequent computation process. Therefore, the auxiliary computing node CS may generate a large quantity of mutually independent random matrix pairs offline in advance, and send random seeds to the computing nodes Alice, Bob, and Carol in an initial trial phase of protocol execution in a manner similar to selling commodities, so that the computing nodes can obtain corresponding random matrix information. This is the origin of the name commodity server CS.

Step 2: After receiving a corresponding random matrix pair (Rₐ, rₐ), the participant Alice computes Â=A+Rₐ internally and sends it to the participant node Bob.

Step 3: After receiving a corresponding random matrix pair (R_{c}, r_{c}), the participant Carol computes Ĉ+C+R_{c} internally and sends it to the participant node Bob.

Step 4: After receiving a corresponding random matrix pair (R_{b}, r_{b}), the participant Bob computes \hat{B}=B+R_{b} internally and synchronously verifies whether the matrix is a non-full rank matrix, and if not, returns to step 1 to reselect a random matrix pair until the condition is met, then continues to compute a matrix M_{b}=Â·R_{b}·Ĉ, sends φ₁=Â·\hat{B} and γ₁=Â·R_{b} to Carol, and sends φ₂=\hat{B}·Ĉ and γ₂=R_{b}·Ĉ to Alice.

Step 5: After receiving the matrix φ₂, γ₂ sent from the node Bob, the participant node Alice successively computes Sₐ=Rₐ·γ₂=Rₐ·R_{b}Ĉ and Mₐ=A·φ₂=A·\hat{B}·Ĉ locally.

Step 6: After receiving the matrix φ₁, γ₁ sent from the node Bob, the participant node Carol successively computes S_{c}=γ₁·R_{c}=ÂR_{b}·R_{c} and M_{c}=φ₁·R_{c}=Â·\hat{B}·R_{c} locally.

Step 7: The participant node Bob internally splits the matrix \hat{B} in a manner of full rank decomposition, to obtain a column full rank matrix B₁∈ [symbol] ^{s×r} and a row full rank matrix B₂ε [symbol] ^{r×t}, where ranks of the non-zero matrix \hat{B} and the split matrices B₁, B₂ meet a constraint condition rank(\hat{B})=rank(B₁)=rank(B₂)=r. The node Bob sends the matrix B₁ to the node Alice, and sends the matrix B₂ to the node Carol.

Step 8: After receiving the matrix B₁ from the node Bob, the participant node Alice internally generates a random matrix Vₐ∈ [symbol] ^{n×m} secretly, computes Tₐ=Mₐ+Sₐ−Vₐ−rₐ and t₁=RₐB₁ locally, and sends Tₐ and t₁ to the node Bob.

Step 9: After receiving the matrix B₂ from the node Bob, the participant node Carol secretly computes t₂=B₂R_{c}, and sends the result t₂ to the node Bob.

Step 10: After receiving the matrices Tₐ and t₁ sent from the node Alice and the matrix t₂ sent from the node Carol, the participant node Bob internally generates a random matrix V_{b}∈ [symbol] ^{n×m} secretly, and secretly computes a matrix S_{b}=t₁·t₂=Rₐ·B₁·B₂R_{c}=Rₐ\hat{B}R_{c} locally, finally obtains, T_{b}=Tₐ−M_{b}+S_{b}−V_{b}−r_{b}, and sends it to the node Carol.

Step 11: After receiving T_{b}, the participant node Carol secretly computes a matrix V_{c}=T_{b}−M_{c}+S_{c}−r_{c} locally.

Step 12: The participants: node Alice, node Bob, and node Carol, separately send final obfuscation split results Vₐ, V_{b}, and V_{c} to a party requesting three-party matrix multiplication, and the requesting party aggregate the split results to obtain a final product ABC=Vₐ+V_{b}+V_{c}.

The existing solutions for the secure two-party inversion computation involve two main approaches. One approach is the outsourcing computation mode, represented by techniques such as matrix blinding and homomorphic encryption. This mode is more suitable for cases where client-side computing resources are limited. While it greatly reduces the computational and communication overhead for the data provider, it transfers the data ownership entirely to a third-party cloud platform, which poses risks of data leakage due to potential security vulnerabilities in the cloud servers. The other approach is the end-to-end multi-party computation mode, represented by techniques such as secret sharing and oblivious transfer. This mode is suitable for data holders with sufficient computing resources. It keeps all the computation and communication tasks local, thereby avoiding the risks of data leakage from third-party servers. However, this mode places relatively high requirements on the reliability of local computing resources and environment. Unlike the end-to-end multi-party computation mode fully implemented at the local computing node and the multi-party computation mode fully outsourced to the cloud, the present disclosure proposes a hybrid multi-party computation mode based on server auxiliary computing nodes. In other words, with external semi-honest auxiliary computing nodes, a computation mode where some computations are executed by the data provider while others are executed collaboratively by external auxiliary server nodes can strike a balance between the computing resource overhead and the trustworthiness of the servers.

The problem of secure two-party matrix inversion computation is essentially a composite operation involving matrices from two parties. Different from the previous version of the secure two-party inversion protocol based on the 2-Party Matrix Secure Multiplication Protocol (2PMP), the core idea of this method is to introduce three external auxiliary computing nodes: P Node, Q Node, and S Node, to transform the problem of secure two-party matrix inversion computation, which requires repeatedly calling the 2PMP protocol for four rounds, into a problem that can be solved by three rounds of parallel computations using a 3-Party Matrix Secure Multiplication Protocol (3PMP). The final computation result is fragmented and stored on the distributed auxiliary computing nodes P, Q, and S, thus significantly reducing the security risks associated with result leakage. Moreover, during the execution of the 3PMP protocol, it is possible to select the previously proposed collusion-resistant methods for the 3PMP protocol based on the security level requirements. This ensures both the security level and the reliability of the computation precision.

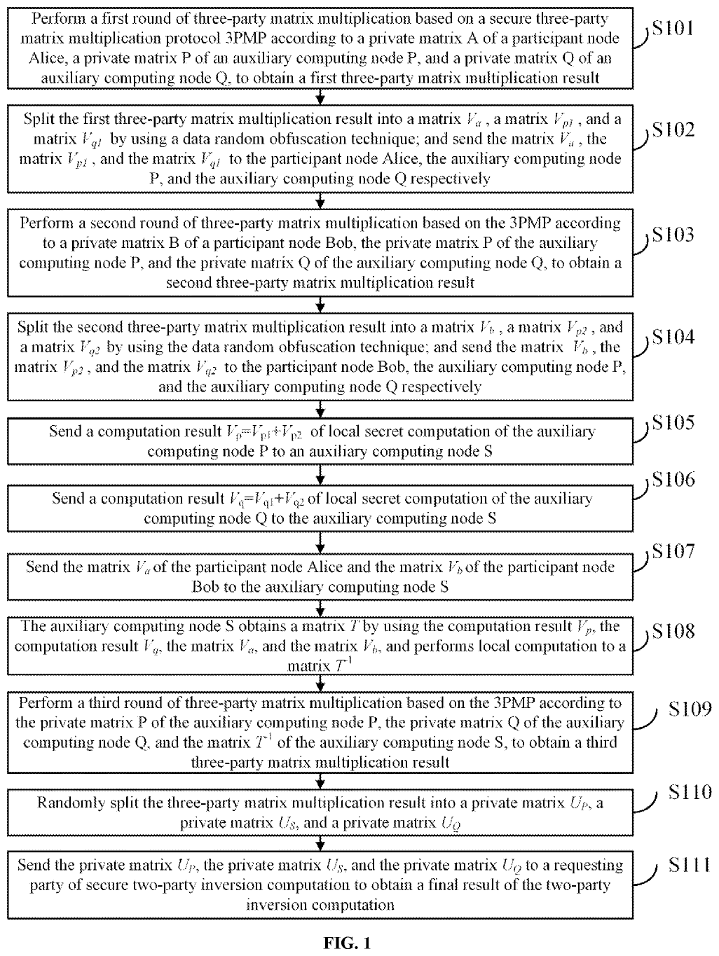

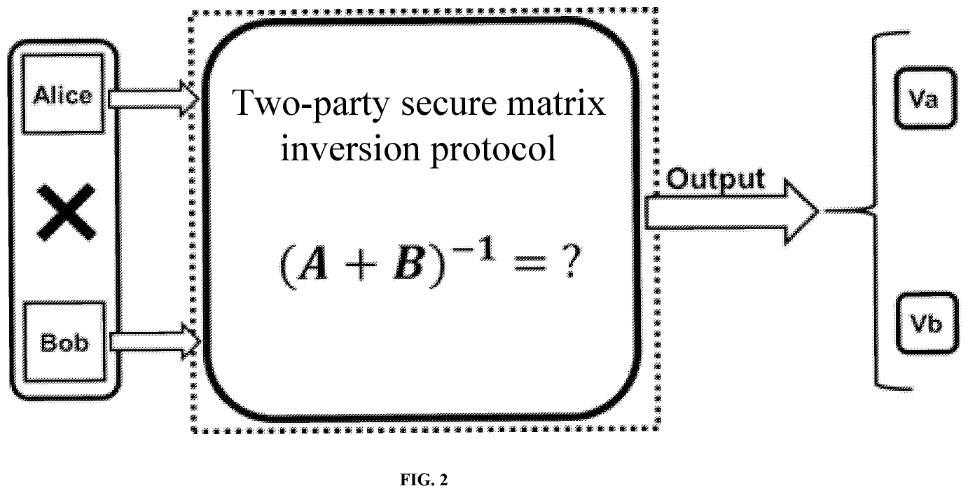

As shown in FIG. 1 and FIG. 2, a server-assisted secure two-party inversion computation method provided by the present disclosure includes the following steps:

S101: Perform a first round of three-party matrix multiplication based on a secure three-party matrix multiplication protocol 3PMP according to a private matrix A of a participant node Alice, a private matrix P of an auxiliary computing node P, and a private matrix Q of an auxiliary computing node Q, to obtain a first three-party matrix multiplication result.

S102: Split the first three-party matrix multiplication result into a matrix Vₐ, a matrix Vₚ₁, and a matrix V_{q1} by using a data random obfuscation technique; and send the matrix Vₐ, the matrix Vₚ₁, and the matrix V_{q1} to the participant node Alice, the auxiliary computing node P, and the auxiliary computing node Q respectively, where a Vₐ, Vₚ₁, V_{q1}∈R^{n×n}, and Vₚ₁+Vₐ+V_{q1}=P×A×Q.

S103: Perform a second round of three-party matrix multiplication based on the 3PMP according to a private matrix B of a participant node Bob, the private matrix P of the auxiliary computing node P, and the private matrix Q of the auxiliary computing node Q, to obtain a second three-party matrix multiplication result.

S104: Split the second three-party matrix multiplication result into a matrix V_{b}, a matrix Vₚ₂, and a matrix V_{q2} by using the data random obfuscation technique; and send the matrix V_{b}, the matrix Vₚ₂, and the matrix V_{q2} to the participant node Bob, the auxiliary computing node P, and the auxiliary computing node Q respectively, where V_{b}, Vₚ₂, V_{q2}∈R^{n×n}, and Vₚ₂+V_{b}+V_{q2}=P×B×Q.

S105: Send a computation result Vₚ=Vₚ₁+Vₚ₂ of local secret computation of the auxiliary computing node P to an auxiliary computing node S.

S106: Send a computation result V_{q}=V_{q1}+V_{q2} of local secret computation of the auxiliary computing node Q to the auxiliary computing node S.

S107: Send the matrix Vₐ of the participant node Alice and the matrix V_{b} of the participant node Bob to the auxiliary computing node S.

S108: The auxiliary computing node S obtains a matrix T=Vₐ+V_{b}+V_{q}+Vₚ=PAQ+PBQ=P(A+B)Q by using the computation result Vₐ, the computation result Vₐ, the matrix Vₐ, and the matrix V_{b}, and performs local computation to a matrix T⁻¹=Q⁻¹(A+B)⁻¹P⁻¹, where T∈R^{n×n}.

S109: Perform a third round of three-party matrix multiplication based on the 3PMP according to the private matrix P of the auxiliary computing node P, the private matrix Q of the auxiliary computing node Q, and the matrix T⁻¹ of the auxiliary computing node S, to obtain a third three-party matrix multiplication result.

S110: Randomly split the three-party matrix multiplication result into a private matrix U_{P}, a private matrix U_{S}, and a private matrix U_{Q}, where U_{P}, U_{S}, U_{Q}∈R^{n×n}.

S111: Send the private matrix U_{P}, the private matrix U_{S}, and the private matrix U_{Q} to a requesting party of secure two-party inversion computation to obtain a final result of the two-party inversion computation, where the participant node Alice owns the private matrix A∈R^{n×n}, the participant node Bob owns the private matrix B⊂R^{n×n}, the auxiliary computing node P owns the random invertible matrix P∈R^{n×n}, and the auxiliary computing node Q owns the random invertible matrix Q∈R^{n×n}.

The final result of the two-party inversion computation is:

$${U}_{p} + {U}_{s} + {U}_{q} = {QT}^{- 1} P = {Q ( {V}_{a} + {V}_{p} + {V}_{q} + {V}_{b} )}^{- 1} P$$

$${U}_{p} + {U}_{s} + {U}_{q} = {Q [ ( {V}_{p 1} + {V}_{a} + {V}_{q 1} ) + ( {V}_{p 1} + {V}_{b} + {V}_{q 2} ) ]}^{- 1} P .$$

The participant node Alice, the participant node Bob, the auxiliary computing node P, the auxiliary computing node Q, and the auxiliary computing node S satisfy a constraint ψ(P Node,A Node,Q Node)=ϕ, a constraint ψ(A Node,B Node)={ϕ}, and a semi-honest model.

ψ represents that there is no collusion among the participant node Bob, the auxiliary computing node P, and the auxiliary computing node Q, and shared data is an empty set, and ψ(A Node,B Node)={ϕ} represents that collusion between the participant node Alice and the participant node Bob is prohibited.

The analysis process of the collusion resistance performance is as follows:

Firstly, this model is established based on two security evaluation criteria: process-level security and result-level security. Here, the model is mainly illustrated by comparison with the matrix blinding technique or the 2PMP-based two-party matrix inversion solution. The reason for this comparison is that solutions using cryptographic techniques such as homomorphic encryption, oblivious transfer (OT), or secret sharing prioritize the protection of information security of the data source by sacrificing communication overhead and computational complexity. This, in turn, compromises the efficiency of protocol execution. On the other hand, the blinding technique or the matrix inversion technique based on the 2PMP, similar to this method, are privacy-preserving computation solutions that either do not introduce or introduce minimal communication and computational overhead using cryptographic tools. In this solution, there are only two data-holding nodes, Alice and Bob, involved in the computation. Apart from Alice and Bob, there are three server nodes, namely P Node, Q Node, and S Node, which serve as auxiliary computing nodes. Therefore, to ensure process-level security and result-level security, the following three prerequisites need to be met:

It is strictly prohibited for three computing nodes involved in the 3PMP protocol to collude simultaneously.

Collusion between original data-holding parties is absolutely forbidden.

The maximum security level currently for all the participant nodes is focused on collusion-level attack risks.

Since computation in this protocol is based on semi-honest participant nodes, all participants will strictly adhere to the computational procedures of the protocol. To satisfy condition 1, for the nodes Alice and Bob nodes as well as the three auxiliary computing nodes, the constraint ψ(P Node,A Node,Q Node)=ϕ should be met. Here, the symbol ψ represents that the three nodes do not collude with each other and have an empty set for shared data. To satisfy condition 2, the nodes Alice and Bob should strictly adhere to the constraint ψ(A Node,B Node)={ϕ}. Similar to the previous constraint, this constraint represents that collusion between Alice and Bob nodes is strictly prohibited. To satisfy condition 3, all the participant nodes in the computation should be at least resilient to collusion-level attacks. In normal circumstances, in secure two-party matrix inversion protocols related to specific requirements, strict process control is necessary to ensure protocol execution procedures. According to the definition of information-theoretic security, if the security of each step in the computation process is ensured, i.e., the security of the sub-protocol 3PMP computation, then it can be assumed that the entire protocol is secure in terms of process-level security. Furthermore, if it can be guaranteed that even in the case of partial leakage of the three sliced data outputs which are eventually sent to the requesting party after the computation is completed, the original data-holding party (Alice or Bob) is still unable to infer the private data of the other party, then it can be considered that the entire protocol is secure in terms of result-level security.

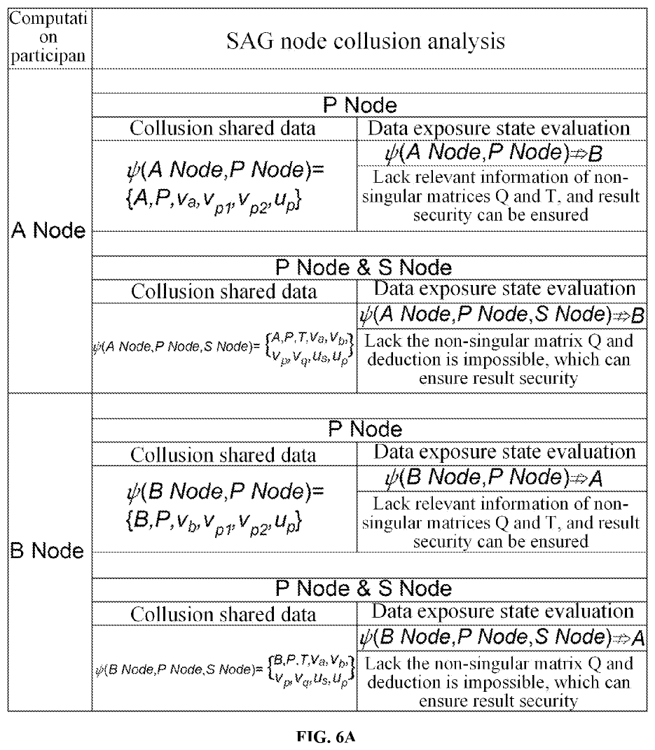

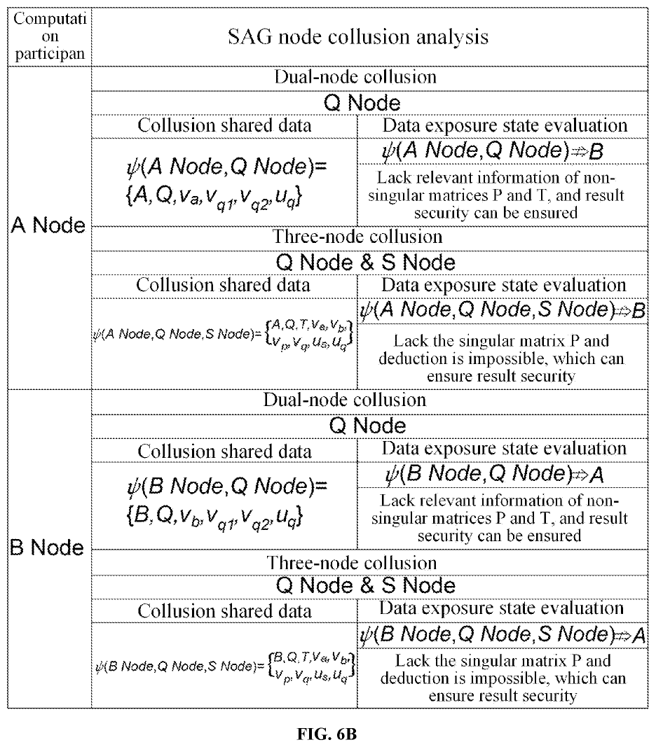

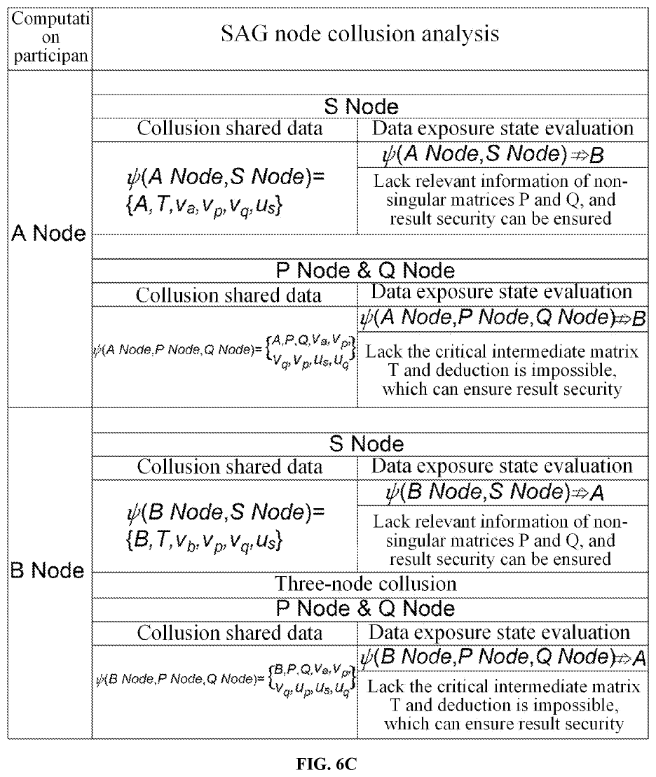

For the process-level security, collusion between Server-Assistant Computing (SAC) nodes is analyzed below. This method, while adhering to the three constraints, addresses potential collusion scenarios as shown in FIGS. 6A-C. It primarily involves collusion between two nodes or collusion among three nodes. Based on the protocol, it is learned that the entire computation process involves only three rounds of 3PMP calls. Even during a single round of 3PMP execution, the security of the sub-protocol execution process can be ensured by employing the anti-collusion methods proposed in the previous 3PMP algorithm. However, for the intermediate computation results, further analysis is required to examine the data exposure state in the collusion analysis of SAC nodes. From the upper and lower parts of the table, it can be seen that this method evaluates the security risks of the secure two-party inversion protocol caused by collusion behaviors with three auxiliary computing nodes based on the parallel relationship of the node A and node B. In the case of collusion between two nodes, Alice may collude with any of the three auxiliary computing nodes: P, Q, or S. However, regardless of the collusion method used, it is not possible to infer the data of the other party based on the intermediate results due to the lack of relevant non-singular matrix complete information [P, Q, T]. In the case of collusion among three nodes, Alice can collude with any two of the three auxiliary computing nodes: P, Q, or S. However, regardless of the collusion method used, it is still not possible to infer the data of the other party based on the intermediate results due to the lack of relevant non-singular matrix complete information [P, Q, T]. Similarly, SAC collusion analysis can be performed on the node Bob. The results are similar to the previous analysis. Therefore, it can be considered that the protocol is compliant with process-level computational security. Regarding result security, after the computation is completed, the data holders of the final result are auxiliary computing nodes P, Q, and S. When the result fragmented data uₚ, u_{q}, uₛ is sent to the requesting party, even if there is leakage of the fragmented data uᵢ(i=p, q, s) related to one or two nodes, Alice or Bob cannot infer the private data of the other party based on the leaked fragmented data information (the final result (A+B)⁻¹ cannot be deduced from the incomplete data [uₚ,u_{q},uₛ]). Therefore, it can be considered that this algorithm satisfies result security.

In summary, under the assumption of a semi-honest model, all participant nodes, whether it is the local data holder node Alice or Bob, or the service auxiliary computing node Node P, Node Q, or Node S, strictly follow the protocol flow and execute the computation process. Even in the presence of a few malicious nodes colluding or attempting to infer other participants' private data, this solution can effectively ensure the process security and result security throughout the entire computation task, given the satisfaction of the prerequisite constraints. Therefore, this protocol is considered to be compliant with computational security.

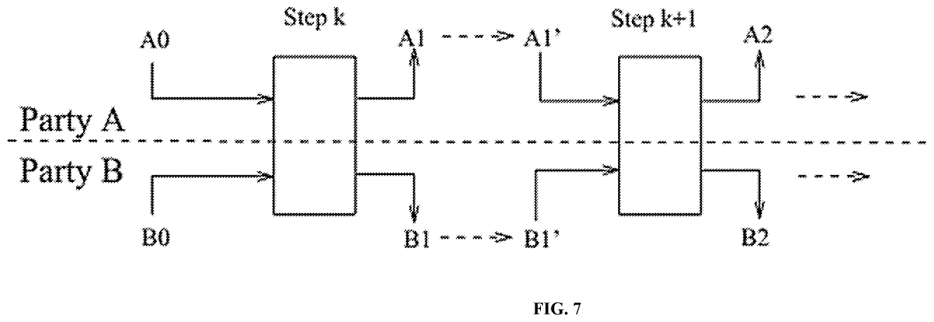

As shown in FIG. 7, for the majority of multi-party computations, the process of achieving secure computation typically involves multiple steps. How to ensure security of intermediate results is an inevitable problem. For example, when a product a×b of two-party matrices is used as an intermediate result of the computation, whether the participant node Alice or the node Bod obtains the result of the final matrix a×b, it is possible to reversely deduce data information of the other party. Therefore, not only security of an original data input but also security of an intermediate value should be ensured during the privacy-preserving computation process.

In order to solve this problem, a data obfuscation encryption technique is proposed, in which an arbitrary multi-item operation is disassembled into a new multi-item addition method for obfuscating and computing a result of an intermediate value. To illustrate its principle more easily, a basic two-party operation type is exemplified herein, and its principle is shown in FIG. 3. It is assumed that Sₖ=Fₖ(Aᵢ,Bᵢ), where Fₖ is a target computation function, Aᵢ is private data belonging to the organization Alice, and Bᵢ is private data belonging to the organization Bob. When each step of a secure multi-party computation protocol is performed, the intermediate result Sₖ strictly follows the following constraint: Alice only knows its own computation result Aₖ, Bob only knows Bₖ, and Aₖ+Bₖ=Sₖ. The formula [Aᵢ:Bᵢ]⇒[Aₖ:Bₖ|Aₖ+Bₖ=Fₖ(Aᵢ,Bᵢ)] represents a transfer process of the intermediate value, during which Alice and Bod are not allowed to exchange each other's data information, including Aₖ and Bₖ split from the computation intermediate result. Provided that the intermediate value is divided into two pieces of random data items at each step during computation, it is ensured that no one can reversely deduce an original data item from the obfuscated and encrypted data, so that the whole process of privacy-preserving computation is highly secure.

The secure three-party multiplication protocol of the 3PMP protocol is implemented using secret sharing, oblivious transfer, garbled circuit framework ABY3, and fully homomorphic encryption.

Corresponding to the foregoing method, the present disclosure provides a server-assisted secure two-party inversion computation system, including a first computation unit, a first sending unit, a second computation unit, a second sending unit, a first computation result sending unit, a second computation result sending unit, a third sending unit, a computation unit of auxiliary computing node S, a third computation unit, a private matrix splitting unit, and a two-party inversion computation result determining unit.

The first computation unit is configured to perform a first round of three-party matrix multiplication based on a secure three-party matrix multiplication protocol 3PMP according to a private matrix A of a participant node Alice, a private matrix P of an auxiliary computing node P, and a private matrix Q of an auxiliary computing node Q, to obtain a first three-party matrix multiplication result.

The first sending unit is configured to split the first three-party matrix multiplication result into a matrix Vₐ, a matrix Vₚ₁, and a matrix V_{q1} by using a data random obfuscation technique; and send the matrix Vₐ, the matrix Vₚ₁, and the matrix V_{q1} to the participant node Alice, the auxiliary computing node P, and the auxiliary computing node Q respectively, where Vₐ, Vₚ₁, V_{q1}∈R^{n×n}, and Vₚ₁−Vₐ+V_{q1}=P×A×Q.

The second computation unit, is configured to perform a second round of three-party matrix multiplication based on the 3PMP according to a private matrix B of a participant node Bob, the private matrix P of the auxiliary computing node P, and the private matrix Q of the auxiliary computing node Q, to obtain a second three-party matrix multiplication result.

The second sending unit is configured to split the second three-party matrix multiplication result into a matrix V_{b}, a matrix Vₚ₂, and a matrix V_{q2} by using the data random obfuscation technique; and send the matrix V_{b}, the matrix Vₚ₂, and the matrix V_{q2} to the participant node Bob, the auxiliary computing node P, and the auxiliary computing node Q respectively, where an V_{b}, Vₚ₂, V_{q2}∈R^{n×n}, and Vₚ₂+V_{b}+V_{q2}=P×B×Q.

The first computation result sending unit is configured to send a computation result Vₚ=Vₚ₁+Vₚ₂ of local secret computation of the auxiliary computing node P to an auxiliary computing node S.

The second computation result sending unit is configured to send a computation result V_{q}−V_{q1}+V_{q2} of local secret computation of the auxiliary computing node Q to the auxiliary computing node S;

The third sending unit is configured to send the matrix Vₐ of the participant node Alice and the matrix V_{b} of the participant node Bob to the auxiliary computing node S.

The computation unit of auxiliary computing node S is configured to obtain, by the auxiliary computing node S, a matrix T=Vₐ+V_{b}+V_{q}+Vₚ=PAQ+PBQ=P(A+B)Q by using the computation result Vₐ, the computation result Vₐ, the matrix Vₐ, and the matrix V_{b}, and perform local computation to obtain a matrix T⁻¹=Q⁻¹(A+B)⁻¹P⁻¹, where T∈R^{n×n}.

The third computation unit is configured to perform a third round of three-party matrix multiplication based on the 3PMP protocol according to the private matrix P of the auxiliary computing node P, the private matrix Q of the auxiliary computing node Q, and the matrix T⁻¹ of the auxiliary computing node S, to obtain a third three-party matrix multiplication result.

The private matrix splitting unit is configured to randomly split the three-party matrix multiplication result into a private matrix U_{P}, a private matrix U_{S}, and a private matrix U_{Q}, where U_{P}, U_{S}, U_{Q}∈R^{n×n}.

The two-party inversion computation result determining module is configured to send the private matrix U_{P}, the private matrix U_{S}, and the private matrix U_{Q} to a requesting party of secure two-party inversion computation to obtain a final result of the two-party inversion computation, where the participant node Alice owns the private matrix A∈R^{n×n}, the participant node Bob owns the private matrix B∈R^{n×n}, the auxiliary computing node P owns the random invertible matrix P∈R^{n×n}, and the auxiliary computing node Q owns the random invertible matrix Q∈R^{n×n}.

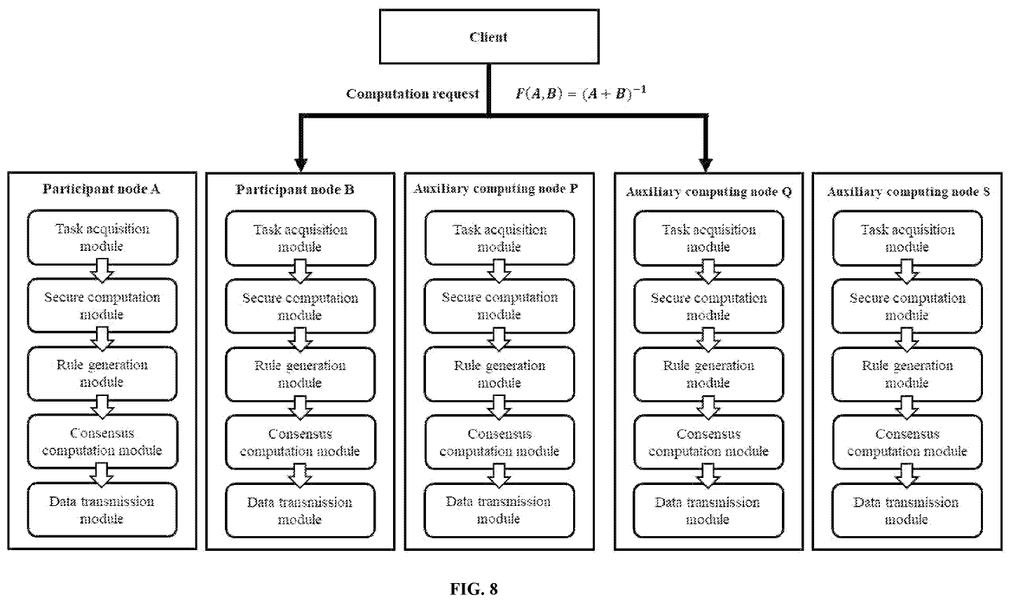

As shown in FIG. 8, a server-assisted secure two-party inversion computation apparatus provided by the present disclosure is applied to the server-assisted secure two-party inversion computation method, and includes a task acquisition module, a secure computation module, a rule generation module, a consensus computation module, and a data transmission module.

The task acquisition module is configured to receive and decode a privacy-preserving computation request from a client.

The secure computation module is configured to automatically match a corresponding two-party secure computation protocol according to the parsed privacy-preserving computation request.

The rule generation module is configured to implement computation task decomposition according to an asynchronous instruction set of the secure computation protocol, where different participant nodes execute collaborative computation according to respective rules.

The consensus computation module is configured to ensure synchronicity and result consistency of computation processes by using a consensus protocol after receiving assigned sub-rules.

The data transmission module is configured to collect computation results from participant nodes and transmit the computation results to a computation requesting party after the computation is completed.

First, a corresponding distributed computing framework needs to be deployed on the two computation participant nodes and three auxiliary computing nodes involved in the two-party secure matrix inversion computation task. An external client sends, through the HTTP or gPRC communication protocol, a request for two-party secure matrix inversion computation to a network side deployed with a distributed computing service. After receiving the request for matrix inversion computation, the task acquisition module parses the request and initiates secure computation service processes for the corresponding computation participant node A, participant node Bob, auxiliary computing node P, auxiliary computing node Q, and auxiliary computing node S. After parsing corresponding computation requirements, the task acquisition module passes the computation requirements to the secure computation module. A joint query is performed through an internal interface of the secure computation module. After a corresponding secure computation protocol is found through matching, the secure computation protocol is synchronized to the rule generation modules in the participant node A, participant node Bob, auxiliary computing node P, auxiliary computing node Q, and auxiliary computing node S. The rule generation module then formulates different asynchronous parallel execution processes according to different subtasks assigned to the participant node A, participant node Bob, auxiliary computing node P, auxiliary computing node Q, and auxiliary computing node S, and maintains communication with the consensus computation module at each step of the execution. While the participant node A, participant node Bob, auxiliary computing node P, auxiliary computing node Q, and auxiliary computing node S execute computation instructions at each step, the consensus computation module broadcasts and maintains result consistency of the distributed computing nodes on the chain, and controls the stability of the execution process. Once the execution of the computation protocol is completed, the two computation participant node A and participant node Bob obtain computation sub-results from each other, and send, through the respective data transmission modules, the obfuscated and split sub-matrices to the requesting party, to obtain a correct computation result.

The present disclosure proposes a two-party secure inversion computation method based on a dual-link parallel computation paradigm with three auxiliary computing nodes. This method addresses the issues of low computational efficiency and high communication overhead in existing solutions that rely on sequential execution using cryptographic tools. The present disclosure aims to achieve a reliable method that can effectively resist collusion among server nodes, addressing the problem of low security defense level in existing outsourced cloud computing approaches. The present disclosure proposes a secure two-party matrix inversion protocol that supports the highest precision of float64 floating-point data operations. By incorporating the three-party matrix multiplication protocol 3PMP with verifiable results, the precision stability and result reliability of the final computation result are ensured. The present disclosure proposes a secure two-party inversion computation protocol that provides dual protection from the process to the result. The 3PMP protocol and output data obfuscation and splitting techniques are employed to guarantee both process-level security and result-level security of the protocol.

Each embodiment in the description is described in a progressive mode, each embodiment focuses on differences from other embodiments, and references can be made to each other for the same and similar parts between embodiments. Since the system disclosed in an embodiment corresponds to the method disclosed in an embodiment, the description is relatively simple, and for related contents, references can be made to the description of the method.

Particular examples are used herein for illustration of principles and implementation modes of the present disclosure. The descriptions of the above embodiments are merely used for assisting in understanding the method of the present disclosure and its core ideas. In addition, those of ordinary skill in the art can make various modifications in terms of particular implementation modes and the scope of application in accordance with the ideas of the present disclosure. In conclusion, the content of the description shall not be construed as limitations to the present disclosure.

1. A server-assisted secure two-party inversion computation method, comprising:
performing a first round of three-party matrix multiplication based on a secure three-party matrix multiplication protocol 3PMP according to a private matrix A of a participant node Alice, a private matrix P of an auxiliary computing node P, and a private matrix Q of an auxiliary computing node Q, to obtain a first three-party matrix multiplication result;
splitting the first three-party matrix multiplication result into a matrix Vₐ, a matrix Vₚ₁, and a matrix V_{q1} by using a data random obfuscation technique; and sending the matrix Vₐ, the matrix Vₚ₁, and the matrix V_{q1} to the participant node Alice, the auxiliary computing node P, and the auxiliary computing node Q respectively, wherein Vₐ, Vₚ₁, V_{q1}∈R^{n×n}, and Vₚ₁+Vₐ+V_{q1}=P×A×Q;
performing a second round of three-party matrix multiplication based on the 3PMP according to a private matrix B of a participant node Bob, the private matrix P of the auxiliary computing node P, and the private matrix Q of the auxiliary computing node Q, to obtain a second three-party matrix multiplication result;
splitting the second three-party matrix multiplication result into a matrix V_{b}, a matrix Vₚ₂, and a matrix V_{q2} by using the data random obfuscation technique; and sending the matrix V_{b}, the matrix Vₚ₂, and the matrix V_{q2} to the participant node Bob, the auxiliary computing node P, and the auxiliary computing node Q respectively, wherein V_{b}, Vₚ₂, V_{q2}∈R^{n×n}, and Vₚ₂+V_{b}+V_{q2}=P×B×Q;
sending a computation result Vₚ=Vₚ₁+Vₚ₂ of local secret computation of the auxiliary computing node P to an auxiliary computing node S;
sending a computation result V_{q}+V_{q1}=V_{q2} of local secret computation of the auxiliary computing node Q to the auxiliary computing node S;
sending the matrix Vₐ of the participant node Alice and the matrix V_{b} of the participant node Bob to the auxiliary computing node S;
obtaining, by the auxiliary computing node S, a matrix T=Vₐ+V_{b}+V_{q}+Vₚ=PAQ+PBQ=P(A+B)Q by using the computation result Vₚ, the computation result V_{q}, the matrix Vₐ, and the matrix V_{b}, and performing local computation to a matrix T⁻¹=Q⁻¹(A+B)⁻¹P⁻¹, wherein T∈R^{n×n};
performing a third round of three-party matrix multiplication based on the 3PMP protocol according to the private matrix P of the auxiliary computing node P, the private matrix Q of the auxiliary computing node Q, and the matrix T⁻¹ of the auxiliary computing node S, to obtain a third three-party matrix multiplication result;
randomly splitting the third three-party matrix multiplication result into a private matrix U_{P}, a private matrix U_{S}, and a private matrix U_{Q}, wherein U_{P}, U_{S}, U_{Q}∈R^{n×n}; and
sending the private matrix U_{P}, the private matrix U_{S}, and the private matrix U_{Q} to a requesting party of secure two-party inversion computation to obtain a final result of the two-party inversion computation, where the participant node Alice owns the private matrix A∈R^{n×n}, the participant node Bob owns the private matrix B∈R^{n×n}, the auxiliary computing node P owns the random invertible matrix P∈R^{n×n}, and the auxiliary computing node Q owns the random invertible matrix Q∈R^{n×n}.

2. The server-assisted secure two-party inversion computation method according to claim 1, wherein the final result of the two-party inversion computation is:
$${U}_{p} + {U}_{s} + {U}_{q} = {QT}^{- 1} P = {Q ( {V}_{a} + {V}_{p} + {V}_{q} + {V}_{b} )}^{- 1} P$$
$${U}_{p} + {U}_{s} + {U}_{q} = {Q [ ( {V}_{p 1} + {V}_{a} + {V}_{q 1} ) + ( {V}_{p 1} + {V}_{b} + {V}_{q 2} ) ]}^{- 1} P .$$

3. The server-assisted secure two-party inversion computation method according to claim 1, wherein the participant node Alice, the participant node Bob, the auxiliary computing node P, the auxiliary computing node Q, and the auxiliary computing node S satisfy a constraint ψ(PNode,A Node,Q Node)=ϕ, a constraint ψ(A Node,B Node)={ϕ}, and a semi-honest model,
wherein ψ represents the participant node Bob, the auxiliary computing node P, and the auxiliary computing node Q do not collude with each other and have an empty set for shared data, and ψ(A Node,B Node)={ϕ} represents that collusion between the participant node Alice and the participant node Bob is prohibited.

4. The server-assisted secure two-party inversion computation method according to claim 1, wherein the secure three-party multiplication protocol of the 3PMP protocol is implemented using secret sharing, oblivious transfer, garbled circuit framework ABY3, and fully homomorphic encryption.

5. A server-assisted secure two-party inversion computation system, comprising:
a first computation unit configured to perform a first round of three-party matrix multiplication based on a secure three-party matrix multiplication protocol 3PMP according to a private matrix A of a participant node Alice, a private matrix P of an auxiliary computing node P, and a private matrix Q of an auxiliary computing node Q, to obtain a first three-party matrix multiplication result;
a first sending unit configured to split the first three-party matrix multiplication result into a matrix Vₐ, a matrix Vₚ₁, and a matrix V_{q1} by using a data random obfuscation technique; and send the matrix Vₐ, the matrix Vₚ₁, and the matrix V_{q1} to the participant node Alice, the auxiliary computing node P, and the auxiliary computing node Q respectively, wherein Vₐ, Vₚ₁, V_{q1}∈R^{n×n}, and Vₚ₁+Vₐ+V_{q1}=P×A×Q;
a second computation unit configured to perform a second round of three-party matrix multiplication based on the 3PMP according to a private matrix B of a participant node Bob, the private matrix P of the auxiliary computing node P, and the private matrix Q of the auxiliary computing node Q, to obtain a second three-party matrix multiplication result;
a second sending unit configured to split the second three-party matrix multiplication result into a matrix V_{b}, a matrix Vₚ₂, and a matrix V_{q2} by using the data random obfuscation technique; and send the matrix V_{b}, the matrix Vₚ₂, and the matrix V_{q2} to the participant node Bob, the auxiliary computing node P, and the auxiliary computing node Q respectively, wherein V_{b}, Vₚ₂, V_{q2}∈R^{n×n}, and Vₚ₂+V_{b}+V_{q2}=P×B×Q;
a first computation result sending unit configured to send a computation result Vₚ=Vₚ₁+Vₚ₂ of local secret computation of the auxiliary computing node P to an auxiliary computing node S;
a second computation result sending unit configured to send a computation result V_{q}=V_{q1}+V_{q2} of local secret computation of the auxiliary computing node Q to the auxiliary computing node S;
a third sending unit configured to send the matrix Vₐ of the participant node Alice and the matrix V_{b} of the participant node Bob to the auxiliary computing node S;
a computation unit of auxiliary computing node S, configured to obtain, by the auxiliary computing node S, a matrix T=Vₐ+V_{b}+V_{q}+Vₚ=PAQ=PBQ=P(A+B)Q by using the computation result Vₚ, the computation result V_{q}, the matrix Vₐ, and the matrix V_{b}, and perform local computation to obtain a matrix T⁻¹=Q⁻¹(A+B)⁻¹P⁻¹, wherein T∈R^{n×n};
a third computation unit configured to perform a third round of three-party matrix multiplication based on the 3PMP protocol according to the private matrix P of the auxiliary computing node P, the private matrix Q of the auxiliary computing node Q, and the matrix T⁻¹ of the auxiliary computing node S, to obtain a third three-party matrix multiplication result;
a private matrix splitting unit configured to randomly split the three-party matrix multiplication result into a private matrix U_{P}, a private matrix U_{S}, and a private matrix U_{Q}, wherein U_{P}, U_{S}, U_{Q}∈R^{n×n}; and
a two-party inversion computation result determining module configured to send the private matrix U_{P}, the private matrix U_{S}, and the private matrix U_{Q} to a requesting party of secure two-party inversion computation to obtain a final result of the two-party inversion computation, wherein the participant node Alice owns the private matrix A∈R^{n×n}, the participant node Bob owns the private matrix B∈R^{n×n}, the auxiliary computing node P owns the random invertible matrix P∈R^{n×n}, and the auxiliary computing node Q owns the random invertible matrix Q∈R^{n×n}.

6. A server-assisted secure two-party inversion computation apparatus, applied to the server-assisted secure two-party inversion computation method according to claim 1, comprising: a task acquisition module, a secure computation module, a rule generation module, a consensus computation module, and a data transmission module,
wherein the task acquisition module is configured to receive and decode a privacy-preserving computation request from a client;
the secure computation module is configured to automatically match a corresponding two-party secure computation protocol according to the parsed privacy-preserving computation request;
the rule generation module is configured to implement computation task decomposition according to an asynchronous instruction set of the secure computation protocol, wherein different participant nodes execute collaborative computation according to respective rules;
the consensus computation module is configured to ensure synchronicity and result consistency of computation processes by using a consensus protocol after receiving assigned sub-rules;
the data transmission module is configured to collect computation results from participant nodes and transmit the computation results to a computation requesting party after the computation is completed; and
after receiving a request for matrix inversion computation, the task acquisition module parses the request and initiates secure computation service processes for the corresponding computation participant node A, participant node Bob, auxiliary computing node P, auxiliary computing node Q, and auxiliary computing node S; after parsing corresponding computation requirements, the task acquisition module passes the computation requirements to the secure computation module; a joint query is performed through an internal interface of the secure computation module; after a corresponding secure computation protocol is found through matching, the secure computation protocol is synchronized to the rule generation modules in the participant node A, participant node Bob, auxiliary computing node P, auxiliary computing node Q, and auxiliary computing node S; the rule generation modules then formulates different asynchronous parallel execution processes according to different subtasks assigned to the participant node A, participant node Bob, auxiliary computing node P, auxiliary computing node Q, and auxiliary computing node S, and maintains communication with the consensus computation module at each step of the execution; while the participant node A, participant node Bob, auxiliary computing node P, auxiliary computing node Q, and auxiliary computing node S execute computation instructions at each step, the consensus computation module broadcasts and maintains result consistency of the distributed computing nodes on the chain, and controls the stability of the execution process; once the execution of the computation protocol is completed, the two computation participant node A and participant node Bob obtain computation sub-results from each other, and send, through the respective data transmission modules, the obfuscated and split sub-matrices to the requesting party, to obtain a correct computation result.

7. The server-assisted secure two-party inversion computation apparatus according to claim 6, wherein the final result of the two-party inversion computation is:
$${U}_{p} + {U}_{s} + {U}_{q} = {QT}^{- 1} P = {Q ( {V}_{a} + {V}_{p} + {V}_{q} + {V}_{b} )}^{- 1} P$$
$${U}_{p} + {U}_{s} + {U}_{q} = {Q [ ( {V}_{p 1} + {V}_{a} + {V}_{q 1} ) + ( {V}_{p 1} + {V}_{b} + {V}_{q 2} ) ]}^{- 1} P .$$

8. The server-assisted secure two-party inversion computation apparatus according to claim 6, wherein the participant node Alice, the participant node Bob, the auxiliary computing node P, the auxiliary computing node Q, and the auxiliary computing node S satisfy a constraint ψ(P Node,A Node,Q Node)=ϕ, a constraint ψ(A Node,B Node)={ϕ}, and a semi-honest model,
wherein ψ represents the participant node Bob, the auxiliary computing node P, and the auxiliary computing node Q do not collude with each other and have an empty set for shared data, and ψ(A Node,B Node)={ϕ} represents that collusion between the participant node Alice and the participant node Bob is prohibited.

9. The server-assisted secure two-party inversion computation apparatus according to claim 6, wherein the secure three-party multiplication protocol of the 3PMP protocol is implemented using secret sharing, oblivious transfer, garbled circuit framework ABY3, and fully homomorphic encryption.
